(19) United States
(12) Patent Application Publication
(10) Pub. No.: US 2003/0034379 A1
(43) Pub. Date: Feb. 20, 2003

(54) Method of repairing superalloy directional castings

(76) Inventors: Melvin Robert Jackson, Niskayuna, NY (US); Michael Francis Xavier Gigliotti JR., Scotia, NY (US); Ann Melinda Ritter, Niskayuna, NY (US); Lee Cranford Perocchi, Schenectady, NY (US); Robert John Zabala, Schenectady, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/682,295

(22) Filed: Aug. 16, 2001

(51) Int. Cl. B23K 31/02; B23K 35/12

(52) U.S. Cl. 228/119; 228/245

(57) ABSTRACT

A method of repairing cracks, imperfections, and the like in a cast article of superalloy composition having a directionally oriented microstructure and growth axis. An aperture, usually frustois created in the article in the location of the crack or imperfection. A plug, having a second directionally oriented microstructure having a directional microstructure with a growth axis and a superalloy composition substantially identical to the article superalloy composition, is created. Such plug further possesses an inner end, an outer end, and a surface therebetween. The plug is inserted into the aperture whereby the plug growth axis is oriented in alignment with the article growth axis. Bonding material is applied between the surfaces of the plug and the aperture, before or after insertion of the plug into the aperture. The article is thereafter heated such that the bonding material joins the surface of the plug and the aperture. The outer end of the plug thereafter is polished so that such outer end is approximately level with the article″s′outer wall. The process can include creating a frame of reference between the plug and the aperture, such that the growth axis of the plug″s′second directional microstructure can be aligned with the first growth axis of the article″s′first directional microstructure upon insertion of the plug into the aperture. A plug made in accordance with the aforesaid method is further disclosed and claimed.

### BACKGROUND OF INVENTION

The present invention pertains to the repair of a cast article, and more particularly to a method of repair of an article, having a directionally oriented microstructure and a superalloy composition.

Certain articles, such as airfoils and buckets for the hot sections of power-generating gas turbines, are typically constructed of superalloys having directionally oriented microstructures. Superalloys having directionally oriented microstructures are needed to satisfy the mechanical demands for creep resistance or fatigue resistance to achieve the desired design life. Directional microstructures can be produced using directional solidification processes, which result in either elongated polycrystalline grains or single crystals.

Due to the extreme conditions in which such articles, such as, for example, airfoils, must operate, the control of the thickness of the walls of the airfoil when such airfoil is cast is critical. For example, an airfoil can be cast as a hollow structure with complex cooling circuits inside it. The complex cooling circuits are required because the temperatures of the hot combustion gases directed at the airfoil during operation are at or above the melting temperature of the superalloy composition of which the airfoil is made. The cooling medium may be air or steam, and if the cooling medium is steam, then the steam will typically be under pressure higher than cooling air pressure. Because of these factors, the airfoil design is sensitive to airfoil wall thickness control. Insufficient thickness results in significant creep damage, while excessive wall thickness results in fatigue damage. An 0.08″ nominal airfoil thickness is predicted to result in an airfoil achieving its design life if actual thickness can be maintained to within 0.02″ of the nominal thickness. Such requirements with respect to control of wall thickness have not been met in production castings of current airfoils.

The casting process required in order to meet the requirements for wall control utilizes ceramic “bumpers” on core surfaces or mold surfaces. For a nominal cast wall thickness of 0.08″+/ceramic bumpers of 0.06″ in height help to control wall thickness by way of the geometric constraints offered by the ceramic bumpers. A large number of bumpers can be needed on each casting to account for likely distortion of the ceramic molds and cores.

After the article is directionally cast, the ceramic bumpers are removed. The wall of the article will be thin wherever there had been ceramic bumpers. In addition, if the mold and the core had been in contact, there would be a small hole in the article at a point of contact, and a corresponding thicker area on the other side of the article. Because variations in wall thickness beyond the design specification of 0.08″+/would probably result in early failure of the article, restoration of wall thickness is required.

The restoration of wall thickness is complicated by the geometry of the article where, for example, the article is an airfoil. At every bumper location there is a unique combination of inner surface and outer surface contours to the airfoil wall. In addition, due to variations in wall thickness within the design specification, no two airfoils will have the same wall thickness profile around the airfoil perimeter or along the airfoil length. The airfoil design allows for filler material to project into the airfoil cooling cavity up to 0.02″ before such filler material results in any detrimental perturbation of the coolant flow. Because the coolant can be steam, the inner contour at each repair should be reasonably smooth so as not to set up a site for crevice corrosion. Outer surface contours are less of a concern, since the outer surface is easily available for hand blending of the filler material back to the airfoil contour.

In addition to repair of articles due to imperfections resulting from the casting process, there is a need for a process whereby a crack in an airfoil can be repaired. Cracks can develop in airfoils after they have been in service for a period of time. Once a crack has been detected, the airfoil is replaced immediately. If the crack can be repaired in such a way that the airfoil can withstand the extreme operating conditions in a turbine, then the operator can thereby be spared the expense of replacing the cracked airfoil with a new airfoil.

In addition to geometric concerns for the restoration of the airfoil wall at weakened locations, there are issues relative to strength. Because steam can be a cooling medium and the steam can be at high pressure, the airfoil can be a pressure vessel. A repair must be able to withstand the interior pressure and be leak In the present designs, the repaired areas should be almost as strong as the surrounding directional material, in terms of creep and fatigue. Further, similar crystallographic orientation is preferred to minimize any concentration in thermal stress due to a change in elastic modulus at the repair.

For the foregoing reasons, there is a need for a method of repairing a cast article having a directionally oriented microstructure and growth axis in which the repair has a growth axis with at least a similar orientation to the growth axis of the article, in order that the repair can withstand the heat and pressure to which it can be subjected such that the article can achieve its design life.

### SUMMARY OF INVENTION

In a broad aspect of the present invention, there is provided a method of repairing an aperture in an article having a first directionally oriented microstructure having a first growth axis and a first superalloy composition, the aperture having an inner surface, the article having a wall, and the wall having a thickness having a first design specification, and the wall having an inner wall surface and an outer wall surface. The process comprises the following steps. First, one determines an area in said article of a reduced wall thickness where the thickness of the wall is less than the first design specification. Second, the aperture can be created in the article in the area of reduced wall thickness, such that a plug can be inserted into the aperture. Third, one selects a filler material having a second directionally oriented microstructure having a second growth axis and a second superalloy composition such that the second growth axis is alignable to the first growth axis, and the second superalloy composition having a composition substantially identical to said first superalloy composition, within a composition specification. Fourth, a plug is created out of the filler material, the plug having an inner end and an outer end, and the plug having an outer surface between the inner end and the outer end, and the plug having dimensions such that the plug can be received in the aperture in a substantially abutting or friction fit, for orientation of the first growth axis in alignment with the second growth axis and such that the inner end does not project beyond the inner wall surface a distance greater than a second design specification. Fifth, one inserts the plug into the aperture whereby the second growth axis is oriented in alignment with the first growth axis. Sixth, a bonding material can be applied between the plug outer surface and the aperture inner surface, before or after insertion of the plug into the aperture. Seventh, one heats the article such that the bonding material joins the aperture inner surface and the plug outer surface. Eighth, and finally, one polishes the outer end of the plug such that the outer end of the plug is approximately level with the outer surface of the article.

The bonding material can be placed on the plug prior to the insertion of the plug into the aperture. Alternatively, or in addition, the bonding material can be applied between the aperture inner surface and the plug outer surface, after insertion of the plug into the aperture, by brazing.

It is preferred that the plug have indexing means as a frame of reference for aligning the filler material growth axis with the article growth axis. The aperture inner surface can have a flat side, the flat side having a predetermined orientation relative to the first growth axis, and the plug outer surface can have a corresponding mating flat side, the plug's flat side having the predetermined orientation to the filler material growth axis, such that the article growth axis and the filler material growth axis can be indexed and aligned upon insertion of the plug into the aperture by abutment of the aperture's flat side and the plug's flat side.

In accordance with another aspect of the invention, in plan view, the aperture inner surface can be a partial circle with a chord, the inner surface's flat side being the chord, and in plan view, the plug outer surface can be another partial circle with a chord, the outer surface's flat side being the chord.

In an alternative embodiment, the aperture inner surface can have a first shape in plan view, the first shape in plan view having a small end of a small diameter and a large end of a large diameter, the ends being joined by tangents, the aperture inner surface having a predetermined orientation relative to the first growth axis, and the plug outer surface having a corresponding shape such that the plug can be received in the aperture in a friction fit whereby the filler material growth axis and the article growth axis can be aligned upon insertion of the plug into the aperture.

It is preferred that the plug outer surface be blasted with an abrasive material prior to the insertion of the plug into the aperture for smoothing the plug outer surface such that any perturbations on the plug outer surface can be removed. Preferably, the abrasive material can be glass beads or walnut shell fragments.

Alternatively, the plug outer surface can be subjected to electro-etching prior to the insertion of the plug into the aperture for smoothing the plug outer surface such that any perturbations on the plug outer surface can be removed

In another aspect of the invention, a plug for repairing a cast article is provided. In such an embodiment of the invention for repairing an aperture in an article cast according to the design specification having a directionally oriented microstructure having a growth axis and a superalloy composition, the aperture having an inner surface, the article having a wall, and the wall having a thickness according to said design specification, and the wall having an inner wall surface and an outer wall surface, comprises a filler material having a directionally oriented microstructure having a growth axis and a superalloy composition such that the filler material growth axis is alignable to the article growth axis, and the filler material superalloy composition having a composition substantially identical to the article superalloy composition, within a composition specification, and an inner end and an outer end, the plug having an outer surface between the inner end and the outer end, and the plug having dimensions such that the plug can be received in the aperture in a friction fit, the plug having indexing means for alignment of the filler material growth axis and the article growth axis.

The plug can have indexing means comprising a flat side having a predetermined orientation relative to the filler material growth axis, such that the article growth axis and the filler material growth axis can be aligned upon insertion of the plug into the aperture having a mating flat side by abutment of the plug flat side and the article flat side. The outer surface of the plug having a flat side can, in plan view, form a partial circle with a chord, the plug's mating flat side being the chord, such that the plug can be inserted into an aperture having a mating flat side, such that the filler material growth axis and the article growth axis can be aligned upon insertion of the plug into the aperture.

In an alternative embodiment, the plug can have a shape in plan view, such shape having a small end of a small diameter and a large end of a large diameter, the small end and the large end being joined by tangents, and the plug outer surface having a predetermined orientation relative to the plug growth axis, and the aperture having a corresponding shape, such that the plug can be received in the aperture in a friction fit whereby the filler material growth axis can be aligned with the article growth axis upon insertion of the plug into the aperture.

### BRIEF DESCRIPTION OF DRAWINGS

The present invention will now be described, by way of example only, with reference to certain embodiments shown in the attached figures in which:

FIG. 1 is a cross section of an airfoil of a blade to be used in a turbine;

FIG. 2 is a cross section of a rod of material having a superalloy composition with a directional microstructure having a growth axis;

FIG. 3 is an enlarged cross section, partly in elevation, of a portion of an article's wall which is of reduced thickness, where an aperture has been created, prior to insertion of a plug therein;

FIG. 4 is an elevation view of an embodiment of a plug;

FIG. 5 is a cross section of an aperture and an elevation view of a plug, following insertion of the plug therein;

FIG. 6 is a plan view of another embodiment of a plug having a partly circular shape, with such circular shape truncated by a chord;

FIG. 7 is an elevation view of a tapered plug having a partly circular shape, in plan view, such circular shape being truncated by a chord; and

FIG. 8 is a plan view of an embodiment of a plug having a small end of a small diameter and a large end of a larger diameter.

### DETAILED DESCRIPTION

Before discussing the present invention in detail, the casting process which results in an article requiring repair in accordance with the present invention will be discussed.

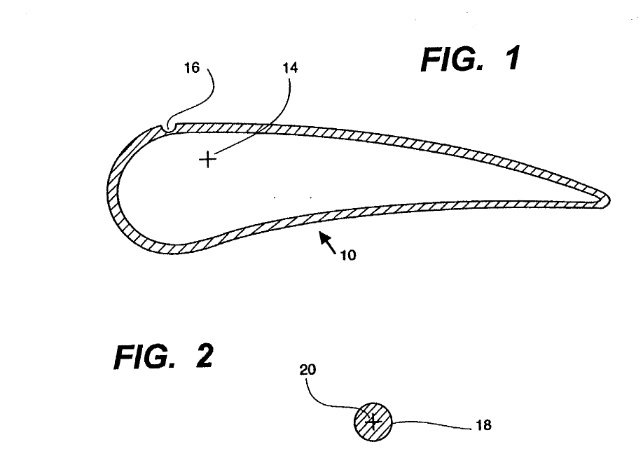

FIG. 1 shows a typical airfoil 10, such as, for example, would be required in a gas turbine, in cross section. The airfoil can have a superalloy composition having a directional microstructure. The growth axis 14 of the directional microstructure of the airfoil' superalloy composition is also shown in FIG. 1.

The thickness for the walls according to a design specification of an airfoil can be, for example, 0.08″, +/The directional microstructure and the design thickness are required to satisfy the mechanical demands for the creep resistance and fatigue resistance necessary to achieve airfoil design life. A directional microstructure may be produced by means of directional solidification in casting the article along the growth axis 14.

The casting process used to satisfy the requirements for wall control can utilize ceramic A “umpers≅” on core surfaces or mold surfaces. For example, each such ceramic bumper used in the casting of the airfoil can be 0.06″ in height, to help control wall thickness. After the article has been cast, the ceramic bumpers can be removed.

At the places in the article where ceramic bumpers had been located and subsequently removed, such as typified by numeral 16, the wall of the article would be thin. Similarly, at other locations, the mold and the core may have been in direct contact, or a ceramic bumper and the mold may have been in direct contact, and at those locations, there will be a small hole in the article′″ wall. Where this occurs, there will also be a corresponding thicker area on the opposite side of the article.

An article having a superalloy composition can have a directionally oriented microstructure of a single crystal superalloy or a polycrystalline superalloy. For the single crystal case where the article is, for example, an airfoil, a ceramic rod mold can be attached to the ceramic airfoil mold/core assembly for the article, so that both are grown from the same single crystal nucleus and have the same superalloy composition. FIG. 2 shows a cross section of a rod 18 which had been cast in this way at the same time as the airfoil had been cast, such rod having a directional microstructure having a growth axis 20 in alignment with article growth axis 14.

After the areas of reduced thickness in an article′″ walls have been determined, an aperture can be made at each such area by drilling out the wall material. Such an aperture is required in order to make the insertion of a plug possible so as to enable each such area to have sufficient wall thickness, for example, the wall of an airfoil is required to be 0.08″+/thick.

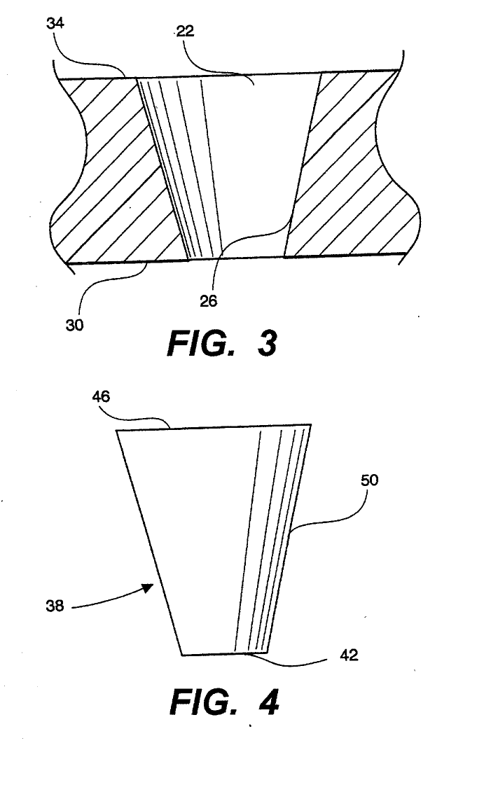

In FIG. 3, an aperture 22 is shown in enlarged cross section, such aperture having an inner surface 26. The inner wall surface 30 and the outer wall surface 34 of the article are also shown in FIG. 3. The aperture shown in FIG. 3 can be made in an area of reduced wall thickness, after the area of reduced wall thickness has been determined. The aperture 22 is shown as being open at the inner wall 30, but it is not necessary that the aperture be open at the inner wall 30.

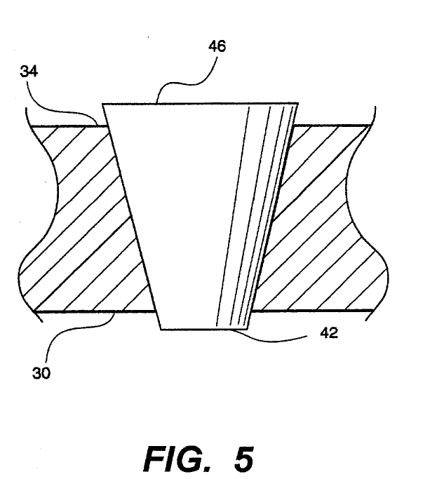

FIG. 4 shows a plug 38 in elevation, such plug having an inner end 42, an outer end 46, and an outer surface 50. The plug 38 is shown as having an outer surface 50 which is tapered, being larger at the outer end 46 than at the inner end 42, but it is not necessary that the plug 38 have such tapered shape. For example, the plug can have a circular right cylindrical shape.

FIG. 5 shows the plug 38 after insertion into the aperture 22, in cross section. In FIG. 5, the inner end 42 of the plug 38 extends beyond the inner wall surface 30, and the outer end 46 extends beyond the outer wall surface 34. It is not necessary that the inner end and the outer end extend beyond the inner wall surface and the outer wall surface respectively after insertion. For example, the airfoil design specification allows for a plug to extend up to approximately 0.02″ beyond the airfoil′″ inner wall. An extension by the plug of more than 0.02″ beyond the airfoil′″ inner wall can result in detrimental perturbation of the flow of coolant within the airfoil. Because the coolant can be steam, there are concerns that the inner contour at each repair should be reasonably smooth so as not to set up a site for crevice corrosion. Outer wall contours are less of a concern in this regard, as the outer end of a plug which extends beyond the airfoil′″ outer wall can be polished or otherwise blended to the contour of the outer wall after insertion of the plug and joining.

The plug and the aperture can have a variety of shapes, in plan view and in cross section. For improved strength of an article after repair, it is critical that the growth axis of the directional microstructure of the article be aligned with the growth axis of the directional microstructure of the plug, and the composition of the superalloy which constitutes the plug be substantially identical to the composition of the superalloy which constitutes the article.

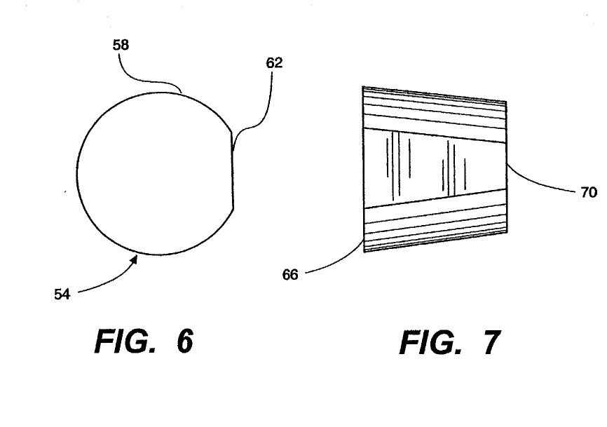

In order to achieve the alignment required, a frame of reference or index, relative to the article growth axis and the filler material growth axis, and common to the plug and the aperture, should be provided. For example, a plug which is a circular right cylinder or a tapered cylinder can be rotated during insertion thereof into an aperture, and the ability to align the plug′″ growth axis of its directional microstructure with the article′″ growth axis of its directional microstructure can thereby be lost. In a preferred embodiment, a plug can be a tapered cylinder which has had the circumference, as viewed in plan view, truncated by a chord. A plan view of such a plug 54 is shown in FIG. 6, such plug having a circumference 58 truncated by a chord, or flat section 62. FIG. 7 is an elevation view of the plug 54 showing the outer end 66 and the inner end 70. The aperture (not shown) into which the plug 54 is to be inserted should have a shape similar to that of the plug 54, so that the plug 54 can be received therein in a friction fit. The orientation of the flat section 62 relative to the growth axis of the directional microstructure of the plug 54 should be substantially identical to the orientation of the corresponding flat section in the aperture inner surface (not shown) relative to the growth axis of the article′″ directional microstructure.

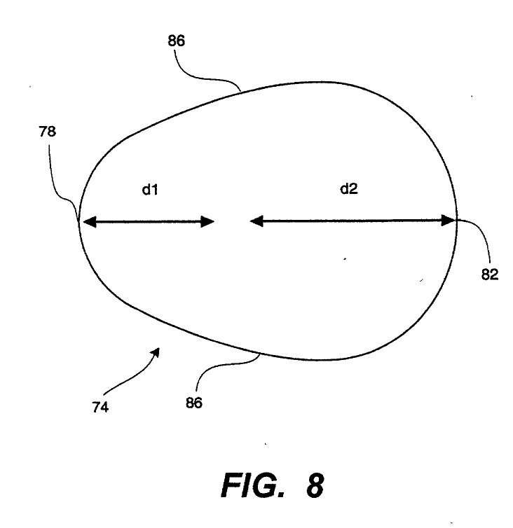

In another embodiment, shown in FIG. 8, the plug 74 can have, in plan view, a small end 78 with a small diameter d1 and a large end 82 with a large diameter d2, and the ends can be joined by tangents 86. The aperture (not shown) should have the same shape as the plug 74 such that the plug 74 can be received in a friction fit in the aperture, and such that the growth axis of the directional microstructure of the plug 74 can be aligned with the growth axis of the directional microstructure of the article (not shown), and the composition of the superalloy constituting the plug 74 should also be substantially identical to the composition of the superalloy constituting the article.

It may be desirable to make plugs from material stock doped to slightly greater-than-normal levels of grain boundary strengthening additives present in the cast article, such as C, B, Zr, and/or Hf, to insure that there is adequate concentration of such elements at the plug/aperaure interface to ensure as good a bond as possible of the plug in the aperaure.

The method of the invention will now be described with reference to the following none-limitative xample. Most experiments to date have been done by wire EDM′″ng (Electron Discharge Milling) of apertures and plugs, but an aperture could not be created in an airfoil by means of a wire EDM. Instead, an aperture can be created in an airfoil by ram EDM of a shaped tool into the airfoil′″ outer wall. Experiments were carried out to investigate the reproducibility of such an aperture. A ram EDM tool was prepared to produce tapered apertures. Thirty holes were ram EDM′″d into a sheet of single crystal Rene N5™ (which had previously been prepared by producing thirty rights-cylindrical tarter holes by conventional drilling), and scanning electron microscopy was performed to characterize tool wear and the resultant change in aperture shape. For the tapered tool, the small end of the tool is cutting for the full pass through the sheet, while the large end of the tool is involved in cutting only at the endw hen it just reaches the sheet. After the thirty apertures were produced the tool showed substantial wear of the small entry end, but virtually no wear of the end producing the outer region of the tapered aperture. The flat configuration of the tool was difficult to observe on the entry end of the tool due to wear. Comparing the aperture configurations through the thirty apertures, there was a resultant decrease in aperture diameter at the inner surface.

The first aperture was essentially straighth-sided aving been cut with a new tool, while the last aperture was not straightr-sided eflecting the progressive tool wear from the largee-diameter nd just barely involved with cutting to the smalle-diameter nd involved with fullc-thickness utting. The total wear on the small end of the tool resulted in the thirtieth aperture being approximately 0.001″ smaller in diameter than the first aperture at the small ends of the apertures, but essentially equal in diameter at the large ends of the apertures. A variation this large would make accurate fitting of apertures and plugs extremely difficult. The results of this experiment indicate that, in order to overcome this variation, substantial mechanical finishing of the apertures is required or, in the alternative, the use of multiple tapered ram tools, such as coarse, intermediate, and fine tapered cutters, is required.

Bonding material (not shown) such as, for example, boronized surface treatments, thin sputtered layers of commercial or proprietary braze alloys, or a nickel layer (or a layer consisting of some other soft material such as aluminum, cobalt, or platinum that will not result in undesirable metallurgical reactions) or some combination thereof can be applied between the aperture inner surface and the plug outer surface before or after insertion of the plug into the aperture. For example, the plug outer surface can be coated with bonding material prior to insertion into the aperture, and following insertion of the plug, the article can be heat treated such that the plug outer surface is joined to the aperture inner surface.

In another embodiment, the bonding material, for example, braze material such as a powder of a superalloy composition modified by additions of melting point depressants such as B and Si can be added in the space between the aperture inner surface and the plug outer surface and subjected to heating. The braze material can move into such vacant spaces as there may be between the aperture inner surface and the plug outer surface, by means of capillary action.

The plug outer surface can be prepared by blasting it with glass beads or walnut shell fragments, such that perturbations on the plug outer surface can be removed to smooth said outer surface. In another embodiment, the plug outer surface can be subjected to electrot-etching o smooth said outer surface such that perturbations on the plug outer surface can be removed. Chemical etching was also investigated, but it has been found that electropr-etching oduced cleaner surfaces than chemical etching, and worked more quickly. Blasted surfaces, however, appear to be smoother and cleaner.

It was found that residue remained on the surface after electroes-etching pecially in areas near clamps contracting the specimen plug. The surface was relatively rough after electroan-etching d remnants of rema-cast terial were present at the base of the EDM pits. Varying voltage, amperage and etching time did not have a marked effect on roughness. It appeared that extreme surface perturbations were attacked early in the process, resulting in an initial rapid reduction in diameter, but that the more nearlypo-flat rtions of the surface were barely attacked by the electroTh-etching.

The concern with the surface treatments is that harsh treatment can result in a site for recrystallization during high temperature exposure. However, if the re-cast layers are not essentially eliminated, they can serve as nucleation for recrystallization. In experiments to date, no substantial recrystallized zone has been observed at aperture/plug interfaces after joining. This may reflect a dissolution of nucleation sites, during joining, either by the bonding material deposited on the plug surface, or by braze material that melted and flowed in the gaps between plug and aperture.

It will be apparent that, while presently preferred embodiments of the present invention are described herein, variations and modifications will occur to those skilled in the art and should not be considered as departing from the spirit of the invention.

1. A method of repairing a cast article of a superalloy composition having a directionally oriented microstructure and growth axis and an imperfection, comprising the steps of:
(a) forming an aperture in said article in an area of imperfection, such that a plug member can be inserted into said aperture;
(b) selecting a filler material of said superalloy composition having a directionally oriented microstructure and a growth axis, such that said filler material growth axis is alignable to said article growth axis, said filler material having a composition substantially identical to said article;
(c) forming said plug member out of said filler material, said plug member having an inner end and an outer surface between said inner and outer end, said plug member of dimensions such that said plug member can be received in said aperture for orientation of said article growth axis;
(d) inserting said plug into said aperture whereby said filler material growth axis is oriented in alignment with said article growth axis;
(e) applying a bonding material between said plug outer surface and said aperture inner surface, before or after insertion of said plug into said aperture;
(f) heating said article such that said bonding material joins said aperture inner surface and said plug outer surface; and
(g) removing material from said outer end of said plug such that said outer end of said plug is approximately level with said outer surface of said article.

2. A method as set forth in claim 1, wherein said article has a wall, said wall having a thickness according to design specifications, wherein said area of imperfection comprises an area of reduced wall thickness.

3. The method as set forth in claim 1, wherein said plug member frictionally engages said aperture.

4. The method as set forth in claim 1 in which said bonding material is placed on said plug member outer surface prior to the insertion of said plug member into said aperture.

5. The method as set forth in claim 1 in which said bonding material is applied between said aperture inner surface and said plug member outer surface, after insertion of said plug member into said aperture, by brazing.

6. The method as set forth in claim 1, wherein said plug member is of a dimension such that outer end of said plug member after insertion into said aperture does not substantially project beyond said outer wall surface, and said step comprising removal of material from said outer side of said plug member comprises polishing said outer end of said plug member.

7. The method as set forth in claim 1, which each of said plug member and said aperture possess mating engagement means which matingly engage and allow insertion of said plug member within said aperture upon alignment of said plug growth axis with said article growth axis.

8. The method as set forth in claim 7 in which said aperture inner surface has a flat side, said flat side having a predetermined orientation relative to said article growth axis, and said plug member outer surface having a mating flat side, said plug flat side having a predetermined orientation relative to said filler material growth axis, such that said article growth axis and said filler material growth axis can be aligned upon insertion of said plug member into said aperture by abutment of said plug flat side and said aperture flat side.

9. The method as set forth in claim 8 in which, in plan view, said aperture inner surface comprising a first partial circle with a first chord, said aperture flat side comprising said first chord, and in plan view, said plug member comprising a second partial circle with a second chord, said plug flat side comprising said second chord.

10. The method as set forth in claim 1 further comprising blasting said outer surface of said plug member with an abrasive material to smooth said outer surface prior to the insertion of said plug into said aperture.

11. The method as set forth in claim 9 wherein said abrasive material is glass beads or walnut shell fragments.

12. The method as set forth in claim 1 wherein said aperture inner surface has a first shape in plan view having a small end of a small diameter and a large end of a large diameter, said small end and said large end being joined by tangents, said aperture inner surface having a predetermined orientation relative to said article growth axis, and said plug member outer surface having a corresponding shape having a predetermined orientation relative to said filler material growth axis, such that said plug member can be received in said aperture and said filler material growth axis can be aligned with said article growth axis upon insertion of said plug member into said aperture.

13. The method as set forth in claim 12 further comprising blasting said outer surface of said plug member with an abrasive material to smooth said outer surface prior to the insertion of said plug member into said aperture.

14. The method as set forth in claim 12 wherein said plug member is received in said aperture in a friction fit.

15. The method as set forth in claim 1 further comprising electroof-etching said outer surface of said plug member to smooth said outer surface prior to the insertion of said plug into said aperture.

16. The method as set forth in claim 12 further comprising electroof-etching said outer surface of said plug member to smooth said outer surface prior to the insertion of said plug member into said aperture.

17. A plug for filling an aperture in a cast article having a directionally oriented microstructure and a growth axis, comprising:
(a) a filler material of a superalloy composition having a directionally oriented microstructure and a growth axis such that said filler material growth axis is alignable to said article growth axis, and said filler material superalloy composition having a composition substantially identical to said article superalloy composition; and
(b) an indexing means for alignment of said filler material growth axis and said article growth axis when said plug is inserted in said aperture in said article.

18. The plug as set forth in claim 17, said plug possessing mating engagement means which only engage and allow insertion of said plug within said aperture upon alignment of said plug growth axis with said growth axis of said article.

19. The plug as set forth in claim 18, said plug having an outer surface, said plug outer surface having a flat side, said flat side having a predetermined orientation relative to said article growth axis, and said plug outer surface has a mating flat side, said flat side having a predetermined orientation relative to said filler material growth axis, such that said filler material growth axis and said article growth axis can be aligned upon insertion of said plug into said aperture by mating engagement of said flat side and said article flat side.

20. The plug as set forth in claim 19 in which, in plan view, said plug outer surface can form a first partial circle with a first chord, said plug flat side being said first chord, such that said plug can be inserted into an aperture having a mating flat side, such that said filler material growth axis and said article growth axis can be aligned upon insertion of said plug into said aperture.

21. The plug as set forth in claim 19, said plug having a shape in plan view, said shape in plan view having a small end of a small diameter and a large end of a large diameter, said small end and said large end being joined by tangents, and said plug outer surface having a predetermined orientation relative to said plug growth axis, and said aperture having a corresponding shape, such that said plug can be received in said aperture whereby said filler material growth axis can be aligned with said article growth axis upon insertion of said plug into said aperture.
